(19) United States
(12) Patent Application Publication
(10) Pub. No.: US 2024/0066627 A1
(43) Pub. Date: Feb. 29, 2024

(54) LASER ENHANCED MICROWAVE ANNEAL

(71) Applicant: Applied Materials, Inc., Santa Clara, CA (US)

(72) Inventor: Wolfgang R. ADERHOLD, Cupertino, CA (US)

(21) Appl. No.: 18/230,520

(22) Filed: Aug. 4, 2023

Related U.S. Application Data
(60) Provisional application No. 63/400,791, filed on Aug. 25, 2022.

(51) Int. Cl. B23K 26/0622; B23K 26/352; B23K 26/70

(52) U.S. Cl. CPC B23K 26/0624; B23K 26/352; B23K 26/70; B23K 2101/40

(57) ABSTRACT

A method and system for including a microwave anneal combined with a nanosecond laser pulse are provided. The method may include applying continuous electromagnetic energy from a first electromagnetic energy source to a substrate, wherein the substrate has a major surface. The method may further include exposing the substrate to laser pulses from a second electromagnetic energy source while applying the continuous electromagnetic energy, wherein exposing the substrate to each pulse of the laser pulses occurs in phase with the continuous electromagnetic energy.

### CROSS-REFERENCE TO RELATED APPLICATIONS

This application claims the benefit of U.S. Provisional Patent Application Ser. No. 63/400,791, filed Aug. 25, 2022, which is incorporated by reference herein in its entirety.

### TECHNICAL FIELD

The present disclosure generally relates to apparatus and methods for manufacturing a semiconductor device. More particularly, the present disclosure generally relates to an apparatus and a method for thermally processing a substrate.

### BACKGROUND

The importance of defects in semiconductor materials, such as single crystalline silicon, is generally recognized with respect to the physical, optical and electronic properties of these materials. Diffusion rates of dopants during annealing processing, for example, have been demonstrated to depend significantly on the type and abundance of defects, such as interstitials and vacancies, in implanted silicon. In addition, the presence of defects in bulk semiconductor materials has been shown to impact other physical properties such as current flow in integrated circuit (IC) devices and the performance of photoactive devices and gas sensors. Defects provide sites where electrons and holes recombine with enhanced efficiency, for example, which is understood to degrade the performance of host materials.

During annealing, a substrate is typically heated to high temperatures so that various chemical and physical reactions can take place in multiple IC devices defined in the substrate. Annealing recreates a more crystalline structure from regions of the substrate that were previously made amorphous, and “activates” dopants by incorporating their atoms into the crystalline lattice of the substrate. Ordering the crystal lattice and activating dopants reduces resistivity of the doped regions. Thermal processes, such as annealing, involve directing a relatively large amount of thermal energy onto a substrate in a short amount of time, and thereafter rapidly cooling the substrate to terminate the thermal process. Examples of thermal processes that have been widely used for some time include Rapid Thermal Processing (RTP) and impulse (spike) annealing. Although widely used, such processes may not be ideal because these processes ramp the temperature of the wafer too slowly and expose the wafer to elevated temperatures for too long. These problems become more severe with increasing wafer sizes, increasing switching speeds, and/or decreasing feature sizes.

For the foregoing reasons, there is a need for improved apparatus and methods for annealing semiconductor substrates.

### SUMMARY

The present disclosure generally relates to apparatus and methods for manufacturing a semiconductor device. More particularly, the present disclosure generally relates to an apparatus and a method for thermally processing a substrate.

In one aspect, a system for annealing a substrate, suitable for use in semiconductor processing, is provided. The system includes a chamber body defining a processing volume and a substrate support pedestal positioned in the processing volume and movable in an x-y plane. The substrate support pedestal is operable to support a substrate having a major surface. The system further includes a continuous source of microwave energy coupled with the chamber body via a waveguide. The continuous source of microwave energy is positioned to deliver microwave energy to the substrate. The system further includes a pulsed laser source positioned to deliver pulses of laser energy to the substrate.

Implementations may include one or more of the following. The pulsed laser source is selected from a femtosecond laser source, a picosecond laser source, or a nanosecond laser source. Each pulse from the pulsed laser source has a duration in a range from about 1 nanosecond to about 100 nanoseconds. The pulsed laser source has a pulse repetition frequency in the range of 80 kHz to 2 GHz. The pulsed laser source is positioned to deliver the pulses of laser energy perpendicular to the major surface of the substrate. The continuous source of microwave energy is positioned to deliver microwave energy parallel to the major surface of the substrate. The system further includes a system controller connected with the continuous source of microwave energy and the pulsed laser source. The system controller coordinates a phase of the continuous source of microwave energy with the pulses of laser energy provided by the pulsed laser source.

In another aspect, a system for annealing a substrate is provided. The system includes a chamber body defining a processing volume. The chamber body includes a top wall, a bottom wall opposing the top wall, and a sidewall coupling the top wall and the bottom wall. The system further includes a substrate support pedestal positioned in the processing volume and movable in an x-y plane parallel to the top wall. The substrate support pedestal is operable to support a substrate having a major surface. The system further includes a continuous source of electromagnetic energy coupled with the chamber body via a waveguide. The continuous source of electromagnetic energy is positioned to deliver electromagnetic energy to the substrate. The system further includes a pulsed source of electromagnetic energy positioned to deliver pulses of electromagnetic energy to the substrate.

Implementations may include one or more of the following. The continuous source of electromagnetic energy is a microwave source and the pulsed source of electromagnetic energy is a laser source. The pulsed source of electromagnetic energy is positioned to deliver pulses of electromagnetic energy perpendicular to the major surface of the substrate. The continuous source of electromagnetic energy is positioned to deliver microwave energy parallel to the major surface of the substrate. The system further includes a phase-frequency detector operable to detect a phase and/or a frequency of the electromagnetic energy emitted from the continuous source of electromagnetic energy. The system further includes a system controller connected with the phase-frequency detector and the continuous source of electromagnetic energy. The system controller adjusts the pulsed source of electromagnetic energy based on input from the phase-frequency detector.

In yet another aspect, a method of annealing a substrate is provided. The method includes applying continuous electromagnetic energy from a first electromagnetic energy source to a substrate. The substrate has a major surface. The method further includes exposing the substrate to pulses of laser energy from a second electromagnetic energy source while applying the continuous electromagnetic energy.

Implementations may include one or more of the following. Exposing the substrate to the pulses of laser energy occurs in phase with the continuous electromagnetic energy. The continuous electromagnetic energy heats the substrate and the pulses of laser energy heat a defined region of the major surface of the substrate. The first electromagnetic energy source is a microwave source. The second electromagnetic energy source is a pulsed laser source selected from a femtosecond pulsed laser source, a picosecond pulsed laser source, or a nanosecond pulsed laser source. Each pulse of the pulses of laser energy has a duration in a range from about 1 nanosecond to about 100 nanoseconds. The pulsed laser source has a pulse repetition frequency in the range of 80 kHz to 2 GHz. The pulsed laser source is positioned to deliver the pulses of laser energy perpendicular to the major surface of the substrate and the first electromagnetic energy source is positioned to deliver microwave energy parallel to the major surface of the substrate.

In another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above-recited features of the present disclosure can be understood in detail, a more particular description of the aspects, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 illustrates a cross-sectional schematic view of one example of a processing system including a continuous energy source and a pulsed energy source in accordance with one or more implementations of the present disclosure.

FIG. 2 illustrates a cross-sectional schematic view of another example of a processing system including a continuous energy source and a pulsed energy source in accordance with one or more implementations of the present disclosure.

FIG. 3 illustrates a cross-sectional schematic view of yet another example of a processing system including a continuous energy source and a pulsed energy source in accordance with one or more implementations of the present disclosure.

FIG. 4 illustrates an exemplary flow chart of a method in accordance with one or more implementations of the present disclosure.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

The present disclosure generally relates to apparatus and methods for manufacturing a semiconductor device. More particularly, the present disclosure generally relates to an apparatus and a method for thermally processing a substrate.

Various embodiments provide methods and systems including a microwave anneal combined with a nanosecond laser pulse to achieve a unique material state. Various embodiments provide for the interaction of vacancies and interstitials under defined electrical and magnetic fields enabled by laser pulses, for example, nanosecond laser pulses, in phase with microwave or other electrical or magnetic waves applied to a substrate. Various embodiments provide potential new ways of experimenting with material compound fabrication and achieving defect generation and/or annihilation. In various embodiments, a continuous electromagnetic anneal, for example, a continuous microwave anneal, uses electromagnetic waves to interact with free electrons but also the electromagnetic properties of defects in the material, which causes a temperature rise in the material. The temperature and electromagnetic field both cause movement of vacancies and interstitials and lead to a random recombination/generation equilibrium. In various embodiments, while applying continuous electromagnetic energy to the substrate, single electromagnetic pulses are applied to the substrate. These single electromagnetic pulses interact to control temperature independent defect generation and/or annihilation within regions of the substrate.

Examples of devices that can benefit from one or more embodiments of the present disclosure are semiconductor devices with field-effect transistors (FETs). Such a device, for example, is a complementary metal-oxide-semiconductor (CMOS) field effect transistor. The FETs may be p-type, n-type, or a combination thereof. The FETs may be planar devices or three-dimensional (3D) fin-type field-effect transistors, referred to herein as finFET devices. The planar devices refer to non-finFET devices. The finFETs are multi-gate transistors or fin-type multi-gate transistors. The finFET device may be a dual-gate device, tri-gate device, a gate all around (GAA) device, and/or other configuration. The device may be a complementary FET (CFET). The device may include power rails, for example, at the wafer backside, which may enhance activation of phosphorous and boron dopants. The devices may be included in an IC such as a microprocessor, memory device, and/or other IC. One of ordinary skill may recognize other embodiments of semiconductor devices and other devices that may benefit from aspects of the present disclosure.

In general the term “substrates” as used herein refers to objects that can be formed from any material that has some natural electrical conducting ability or a material that can be modified to provide the ability to conduct electricity. Typical substrate materials include, but are not limited to, semiconductors, such as silicon (Si) and germanium (Ge), as well as other compounds that exhibit semiconducting properties. Such semiconductor compounds generally include group III-V and group II-VI compounds. Representative group III-V semiconductor compounds include, but are not limited to, gallium arsenide (GaAs), gallium phosphide (GaP), and gallium nitride (GaN). Generally, the term “semiconductor substrate” includes bulk semiconductor substrates as well as substrates having deposited layers disposed thereon. To this end, the deposited layers in some semiconductor substrates processed by the methods of the present disclosure are formed by either homoepitaxial (e.g., silicon on silicon) or heteroepitaxial (e.g., GaAs on silicon) growth. For example, the methods of the present disclosure may be used with gallium arsenide and gallium nitride substrates formed by heteroepitaxial methods. Similarly, the methods described herein can also be applied to form integrated devices, such as thin-film transistors (TFTs), on relatively thin crystalline silicon layers formed on insulating substrates (e.g., silicon-on-insulator substrates). Additionally, the methods may be used to fabricate photovoltaic devices, such as solar cells. Such devices may comprise layers of conductive, semiconductive, or insulating materials, and may be patterned using a variety of material removal processes. Conductive materials generally include metals. Insulating materials may generally include oxides of metals or semiconductors, or doped semiconductor materials.

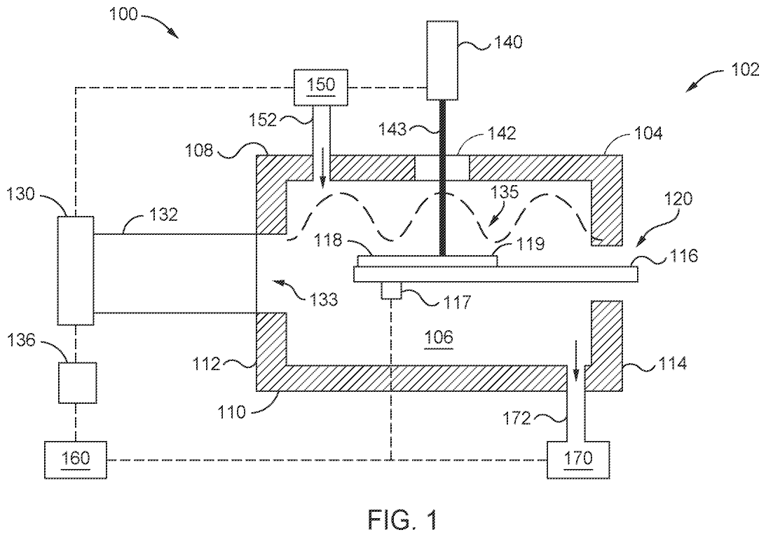

FIG. 1 illustrates a cross-sectional schematic view of one example of a processing system 100 including a first electromagnetic energy source 130, which may be a continuous source, and a second electromagnetic energy source 140, which may be a pulsed source, in accordance with one or more embodiments of the present disclosure. The processing system 100 may be a semiconductor processing system, for example, an annealing system. The processing system 100 may be used to perform a laser-enhanced microwave annealing process as described herein. The processing system 100 includes a processing chamber 102, the first electromagnetic energy source 130, which may be continuous, and the second electromagnetic energy source 140, which may be pulsed. The processing system 100 may further include a gas supply 150, a system controller 160, and an exhaust system 170.

The processing chamber 102 includes a chamber body 104. The chamber body 104 at least partially defining a processing volume 106. In some embodiments, the chamber body 104 includes a top wall 108 (e.g., a ceiling or lid), a bottom wall 110 (e.g., a floor) opposite the top wall 108, a first sidewall 112 coupling the top wall 108 and the bottom wall 110, and a second sidewall 114 opposite the first sidewall 112. The chamber body 104 may be or include any material suitable with the processes performed in the processing chamber 102. For example, suitable materials fort the chamber body 104 include aluminum, stainless steel, ceramic materials, or a combination thereof.

At least one substrate support pedestal 116 is disposed in the processing volume 106 to support one or more substrates 118 thereupon during processing. The substrate(s) 118 can be brought into the processing volume 106 through a loading port 120. The substrate(s) 118 can include a major surface 119 on which devices and/or deposition takes place. The substrate support pedestal 116 may be any support pedestal for holding one or more semiconductor substrates and may include such components as an electrostatic chuck, clamps, edge rings, guide pins, or the like for physically locating and retaining the substrate. In some embodiments, the substrate support pedestal 116 is an X/Y stage translatable in the x-direction and the y-direction, which allows movement of the substrate(s) 118 relative to the second electromagnetic energy source 140. In some embodiments, the substrate support pedestal 116 is configured for rotation during processing. In some embodiments, the substrate support pedestal 116 includes additional components for processing the substrate(s) 118, such as an electrode for supplying DC or RF bias power, systems for the uniform supply or removal of heat from the substrate(s) 118 or a surface of the substrate support pedestal 116, or the like.

In some embodiments, the processing system 100 further includes a substrate temperature sensor 117. The substrate temperature sensor 117 may be embedded in the substrate support pedestal 116. In some embodiments, the substrate temperature sensor 117 is connected to the system controller 160. In some embodiments, the substrate temperature monitored by the substrate temperature sensor 117 is used to control the operation of the first electromagnetic energy source 130 and/or the second electromagnetic energy source 140 in response to the monitored substrate temperature.

The processing system 100 further includes the first electromagnetic energy source 130. In some embodiments, the first electromagnetic energy source 130 may be, but is not limited to, an optical radiation source (e.g., laser or flash lamp), an electron beam source, an ion beam source, and/or a microwave energy source. The first electromagnetic energy source 130 can be continuous or pulsed. In particular embodiments, the first electromagnetic energy source 130 is a microwave energy source. The first electromagnetic energy source 130 may be coupled with the chamber body 104 via a waveguide 132. The electromagnetic energy generated by the first electromagnetic energy source 130 may be supplied into the processing volume 106 from a waveguide launch port 133, which is fluidly coupled with the processing volume 106 via the waveguide 132. Although FIG. 1 shows the waveguide launch port 133 disposed along the first sidewall 112 of the chamber body 104, the waveguide launch port 133 may also be placed in other locations such as the bottom wall 110, the second sidewall 114, the top wall 108, or a combination of different locations.

In some embodiments, the first electromagnetic energy source 130 is positioned to heat the entire substrate(s) 118. The first electromagnetic energy source 130 may be positioned to deliver emitted electromagnetic energy 135 parallel to the major surface 119 of the substrate(s) 118 positioned on the substrate support pedestal 116. The first electromagnetic energy source 130 may be a continuous or pulsed source. In particular embodiments, the first electromagnetic energy source 130 is a continuous source. In particular embodiments, the first electromagnetic energy source 130 is a continuous microwave energy source.

In some embodiments, the first electromagnetic energy source 130 is a microwave generator. The microwave generator generates a fixed frequency microwave or a variable frequency microwave. The microwave generated in the microwave generator is suppled into the processing volume 106 from the waveguide launch port 133 via the waveguide 132. In one embodiment, the frequency of microwave supplied is in a range from about 1 GHz to about 30 GHz. In another embodiment the frequency of microwave supplied is in a range from about 1 GHz to about 10 GHz, or in a range from about 2 GHz to about 5 GHz, for example, 2.45 GHz. However, other applicable frequencies may also be used. The power of microwave may be in range from about 1000 watts to about 7000 watts, or in a range from about 1000 watts to about 3000 watts. In one example, the microwave generator outputs 1500 watts of power at a frequency of about 2.54 gigahertz (GHz).

The system controller 160 may be connected to the first electromagnetic energy source 130 to control the phase, frequency, and other parameters of the emitted electromagnetic energy 135. For example, in some embodiments where the first electromagnetic energy source 130 is a microwave signal generator, the system controller 160 controls the phase, frequency, and other parameters of the microwave signal output from the microwave signal generator.

In some embodiments, the processing system 100 further includes a phase-frequency detector 136 for detecting the phase and/or frequency of the emitted electromagnetic energy 135 from the first electromagnetic energy source 130. The phase-frequency detector 136 may be connected with the first electromagnetic energy source 130 and the system controller 160. The phase-frequency detector 136 may be used in a feedback process, where the phase-frequency detector 136 detects the phase, frequency, and/or other parameters of the emitted electromagnetic energy 135 and the system controller 160 adjusts the first electromagnetic energy source 130 and/or the second electromagnetic energy source 140 based on input from the phase-frequency detector 136. For example, in some embodiments, the phase of the standing wave of the emitted electromagnetic energy 135 from the first electromagnetic energy source 130 is detected by the phase-frequency detector 136 and the pulse of the optical beam 143 from the second electromagnetic energy source 140 is synched with the phase of the standing wave. In other embodiments, the pulse of the optical beam 143 from the second electromagnetic energy source 140 is pulsed independent of the phase of the standing wave of the emitted electromagnetic energy 135 from the first electromagnetic energy source 130.

In other embodiments, the processing system 100 further includes an optical detector (not shown), for example, a photodetector, for detecting the phase and/or frequency of the emitted electromagnetic energy 135 from the first electromagnetic energy source 130. The optical detector may be connected with the first electromagnetic energy source 130 and the system controller 160. A portion of the optical detector may be positioned in the processing volume 106. The optical detector may be used in a feedback process, where the optical detector detects the phase, frequency, and/or other parameters of the emitted electromagnetic energy 135 and the system controller 160 adjusts the first electromagnetic energy source 130 and/or the second electromagnetic energy source 140 based on input from the optical detector. In one example, the optical detector includes a coaxial cable with a core wire probing the inside of the processing volume 106. A signal from the core wire may be used to trigger a pulse of the second electromagnetic energy source 140.

The processing system 100 further includes the second electromagnetic energy source 140. In some embodiments, the second electromagnetic energy source 140 may be, but is not limited to, an optical radiation source (e.g., laser or flash lamp), an electron beam source, an ion beam source, and/or a microwave energy source. In particular embodiments, the second electromagnetic energy source 140 is a laser source. The second electromagnetic energy source 140 may be delivered into the processing volume 106 via a transparent window 142. In some embodiments, as shown in FIG. 1, the transparent window 142 is formed in the top wall 108. The transparent window 142 is configured to allow the optical beam 143 into the processing volume 106. The transparent window 142 may be further configured to prevent microwave energy from escaping from the processing volume 106. For example, the transparent window 142 may have a coating or grating which allows the optical beam 143 to enter the processing volume 106 while preventing microwave energy from exiting the processing volume 106.

In some embodiments, as shown in FIG. 1, the second electromagnetic energy source 140 may be positioned to deliver electromagnetic energy, for example, the optical beam 143, perpendicular to the major surface of the substrate(s) 118 positioned on the substrate support pedestal 116. Although shown as perpendicular, the second electromagnetic energy source 140 may be posited in any suitable orientation to achieve the targeted application of electromagnetic energy. The second electromagnetic energy source 140 is adapted to project an amount of energy on a defined region, or an anneal region, of the major surface 119 of the substrate(s) 118 to preferentially anneal certain targeted regions within the anneal region. In one embodiment, only one or more defined regions of the substrate(s) 118, such as the anneal region, are exposed to the radiation from the second electromagnetic energy source 140 at any given time. In one embodiment, a single area of the major surface 119 of the second electromagnetic energy source 140 is sequentially exposed to a targeted amount of energy delivered from the second electromagnetic energy source 140 to cause the preferential annealing of targeted regions of the substrate. In one example, one area on the surface of the substrate after another is exposed by translating the substrate(s) 118 relative to the output of the second electromagnetic energy source 140 (e.g., translating the substrate support pedestal 116 in the X/Y directions and/or translating the output (e.g., the optical beam 143) of the second electromagnetic energy source 140 relative to the substrate(s) 118). In another embodiment, a complete surface (e.g., major surface 119) of the substrate(s) 118 is exposed all at one time (e.g., all of the anneal regions are simultaneously exposed).

The second electromagnetic energy source 140 may be a continuous or pulsed source. The second electromagnetic energy source 140 may be an optical radiation source (e.g., a laser). In particular embodiments, the second electromagnetic energy source 140 is a pulsed laser source, for example, a nanosecond pulsed laser source. However, depending on the device structure, a femtosecond laser source, an ultraviolet (UV) laser source, a picosecond laser source, or a nanosecond laser source may be applied. In one example, each pulse has a duration in a range from about 10 femtoseconds to about 10 milliseconds, or in a range from about 1 nanosecond to about 10 milliseconds long, or in a range from about 1 nanosecond to 100 nanoseconds, or in a range from about 10 nanoseconds to 100 nanoseconds, or in a range from about 1 nanosecond to about 10 nanoseconds. The laser may have a pulse repetition frequency in the range of 80 kHz to 10 GHz, or in the range of 80 kHZ to 2 GHz, or in the range of 80 kHz to 1 MHz or in the range of 100 kHz to 500 kHz. In one example, the second electromagnetic energy source 140 is a 2 GHz femtosecond-pulsed fiber laser.

In some embodiments where the second electromagnetic energy source 140 is pulsed, the pulse can be synchronized using a master laser pulse method, where at least the master pulse is electronically triggered.

In some embodiments, depending upon the material processes, the second electromagnetic energy source 140 includes a laser have a pulse width in the nanosecond range. Specifically a laser with a wavelength in the visible spectrum (e.g., green band, or 500-540 nm) or the ultra-violet (UV, or 300-400 nm band) or infra-red (IR) band may be used to provide a nanosecond-based laser (e.g., a laser with a pulse width on the order of the nanosecond (e.g., 10⁻⁹ seconds).

In some embodiments, the processing system 100 further includes the gas supply 150. The gas supply 150 may be fluidly coupled with the processing volume via a gas inlet 152. The gas supply 150 provides one or more suitable process gases for processing the substrate(s) 118 and/or for maintaining the processing volume 106 (such as annealing gases, deposition gases, etch gases, cleaning gases, or the like). For example, embodiments of the present disclosure may be used in annealing, deposition, or implant processes that require certain gases be provided to the processing volume 106. The gases may be reactive, such as precursors for deposition processes, or non-reactive, such as inert gases commonly used in conventional thermal processes. The processing volume 106 within which the substrate(s) 118 resides during processing may be evacuated or contain a gas suitable for the targeted process. In one implementation, the gas supply 150 comprises a plurality of gas sources supplying one or more process gases to the processing volume 106. Each process gas may be supplied independently, or in combination with additional process gases. Other components for controlling the flow of gases to the processing volume 106, such as flow controllers, valves, or the like, are, for simplicity, not shown.

In some embodiments, the processing system 100 further includes the system controller 160 operable to facilitate control and automation of various aspects of the thermal processing techniques, for example, the method 400, and the processing system 100. The system controller 160 facilitates the control and automation of the processing system 100 and can include a central processing unit (CPU), memory, and support circuits (or I/O). The CPU may be one of any form of computer processors that are used in industrial settings for controlling various processes and hardware (e.g., conventional electromagnetic radiation detectors, motors, laser hardware, microwave hardware) and monitor the processes (e.g., substrate temperature, substrate support temperature, amount of energy from the microwave source, amount of energy from the pulsed laser, detector signal). Software instructions and data can be coded and stored within the memory for instructing the CPU. The system controller 160 can communicate with one or more of the components of the processing system 100 via, for example, a system bus. A program (or computer instructions) readable by the system controller 160 determines which tasks are performable on a substrate. In some embodiments, the program is software readable by the controller and includes code to monitor and control the substrate position, the amount of energy delivered in the continuous electromagnetic energy emitted, the amount of energy delivered in each electromagnetic pulse, the timing of one or more electromagnetic pulses, the intensity and wavelength as a function of time for each pulse, the temperature of various regions of the substrate, or any combination thereof. Although the system controller 160 is shown as a single system controller, it should be appreciated that multiple system controllers can be used with the embodiments described herein.

In some embodiments, the processing system 100 further includes the exhaust system 170. In one implementation, the exhaust system 170 is coupled to the processing chamber 102 via an exhaust port 172. The exhaust system 170 may be coupled to the processing chamber 102 at any suitable location for exhausting the processing volume 106, such as along the bottom wall 110 of the chamber body 104, as illustrated in FIG. 1. For example, depending upon chamber design and process gas flow considerations, the exhaust port 172 may be located at any suitable location in the processing chamber 102, such as in the sidewall 112, 114 of the processing chamber 102, above or below the surface of the substrate support pedestal 116, in the top wall 108 of the processing chamber 102, in the bottom wall 110 of the processing chamber 102, or in any other suitable location.

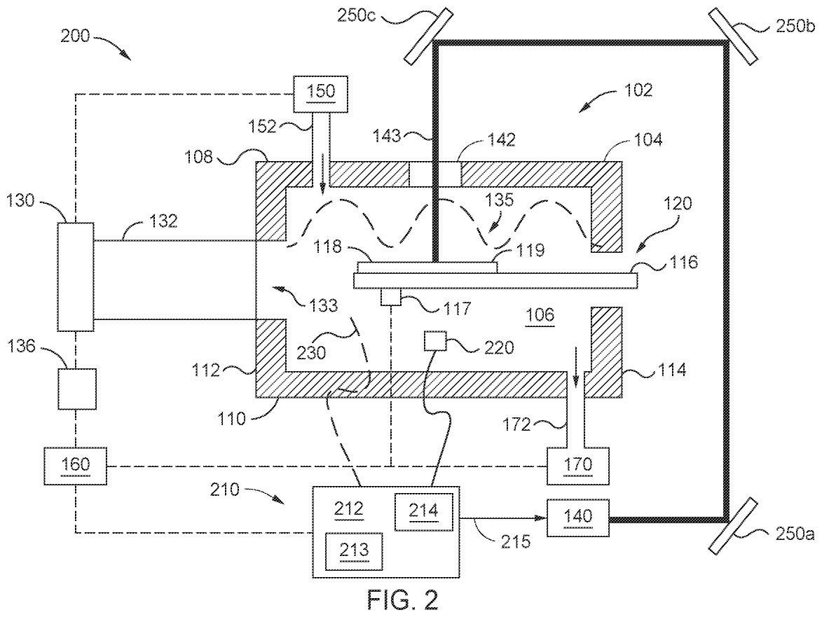

FIG. 2 illustrates a cross-sectional schematic view of another example of a processing system 200 including a continuous energy source and a pulsed energy source in accordance with one or more implementations of the present disclosure. The processing system 200 is similar to the processing system 100 but further includes a timing system 210 for coordinating pulses of the second electromagnetic energy source 140 with the phase of the continuous emitted electromagnetic energy 135 from the first electromagnetic energy source 130. In addition the processing system 200 includes a plurality of reflectors 250a-c for delivering the optical beam 143 from the second electromagnetic energy source 140 into the processing volume 106. It should be understood that the timing system 210 may also be used with the processing system 100.

In the embodiment depicted in FIG. 2, the timing system 210 includes a laser diode driver unit 212. The laser diode driver unit 212 is used to adjust the laser phase in time. The laser diode driver unit 212 includes an electronic pulse generator 213 and a laser diode source 214. The electronic pulse generator 213 is configured to receive a control signal and output a corresponding control current to the laser diode source 214 to make the laser diode source 214 emit a seed laser 215. The laser diode source 214 may be triggered by the electronic pulse generator 213 to pump the second electromagnetic energy source 140 or the main laser.

The timing system 210 further includes a first sensor 220 for detecting the laser pulse of the optical beam 143 from the second electromagnetic energy source 140, for example, a photo detector. The first sensor 220 may be positioned within the processing volume 106 to detect the pulse of the optical beam 143 or laser. The timing system 210 may further include a second sensor 230 for detecting the continuous emitted electromagnetic energy 135 from the first electromagnetic energy source 130, for example, an antenna. In one example, the antenna includes a coaxial cable with a core wire, which probes the inside of the processing volume 106 to detect the phase of the continuous emitted electromagnetic energy 135 and a control signal from the antenna may be communicated to the electronic pulse generator 213 to trigger the laser diode source 214. The second sensor 230 may be positioned within the processing volume 106 to detect the emitted electromagnetic energy 135 or continuous microwave from the first electromagnetic energy source 130. Both the first sensor 220 and the second sensor 230 deliver the time signals to the electronic pulse generator 213 and the electronic pulse generator delivers a trigger signal to the laser diode source 214 to achieve the targeted timing overlap between the continuous emitted electromagnetic energy 135, for example, the continuous microwave, and pulse of the optical beam 143, for example, the pulsed laser.

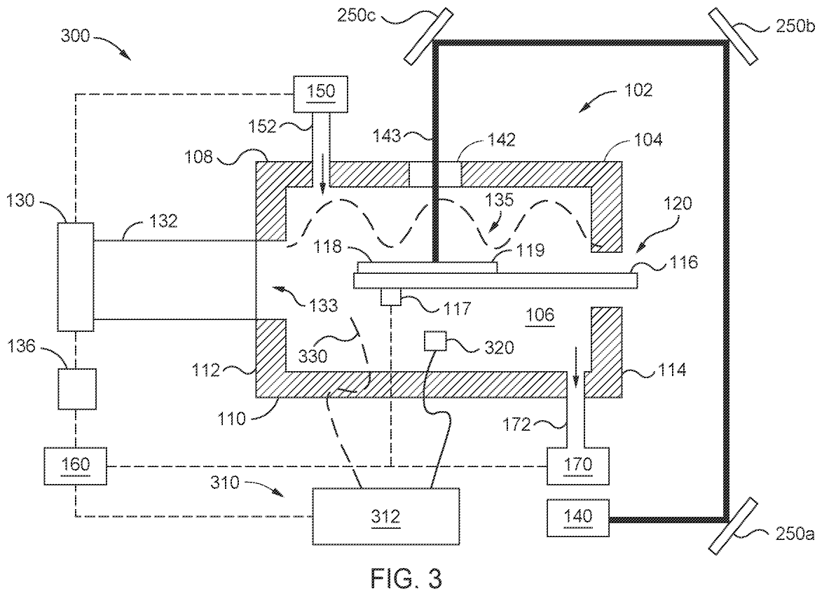

FIG. 3 illustrates a cross-sectional schematic view of yet another example of a processing system 300 including a continuous energy source and a pulsed energy source in accordance with one or more implementations of the present disclosure. The processing system 300 is similar to the processing system 100 and the processing system 200 but further includes a timing system 310 for coordinating the phase of the continuous emitted electromagnetic energy 135 from the first electromagnetic energy source 130 with the pulses of the optical beam 143 from the second electromagnetic energy source 140. In addition, similar to the processing system 200 the processing system 300 includes the plurality of reflectors 250a-c for delivering the optical beam 143 into the processing volume 106. It should be understood that the timing system 310 may also be used with the processing system 100 and/or the processing system 200.

In the embodiment depicted in FIG. 3, the timing system 310 includes a driver unit phase shifter 312. The driver unit phase shifter 312 is used to adjust the phase of the continuous emitted electromagnetic energy 135 from the first electromagnetic energy source 130 in time. The driver unit phase shifter 312 is configured to move the standing wave amplitude of the continuous emitted electromagnetic energy 135 in time to match the pulse of the optical beam 143 from the first electromagnetic energy source 130.

The timing system 310 further includes a first sensor 320 for detecting the laser pulse of the optical beam 143 from the second electromagnetic energy source 140, for example, a photo detector. The first sensor 320 may be positioned within the processing volume 106 to detect the pulse of the optical beam 143 or laser. The timing system 310 may further include a second sensor 330 for detecting the continuous emitted electromagnetic energy 135 from the first electromagnetic energy source 130, for example, an antenna. The second sensor 330 may be positioned within the processing volume 106 to detect the emitted electromagnetic energy 135 or continuous microwave from the first electromagnetic energy source. Both the first sensor 320 and the second sensor 330 deliver the time signals to the driver unit phase shifter 312. Using the information from at least one of the first sensor 320 and the second sensor 330, the driver unit phase shifter 312 can adjust the phase of the continuous emitted electromagnetic energy 135 in time to match the laser pulse of the optical beam 143.

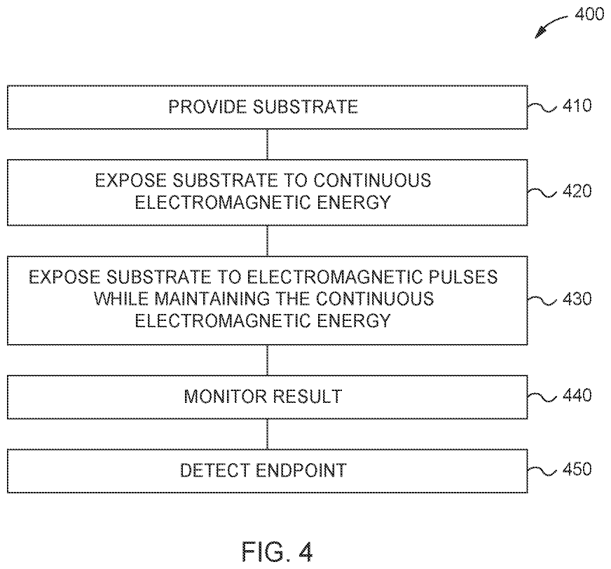

FIG. 4 illustrates an exemplary flow chart of a method 400 in accordance with one or more implementations of the present disclosure. Although the method 400 is described in relation to the processing systems 100, 200, and 300 it will be appreciated that the method 400 is not limited to the processing systems 100, 200, and 300 but instead may be stand-alone independent of the processing systems 100, 200, and 300. Similarly, although the processing systems 100, 200, and 300 are described in relation to the method 400, it will be appreciated that the processing systems 100, 200, and 300 are not limited to the method 400, but instead may also stand-alone independent of the method 400.

FIG. 4 illustrates a flow chart of a method 400 for manufacturing a semiconductor device in accordance with one or more embodiments of the present disclosure. The method 400 may be used to perform a laser-enhanced microwave annealing process. At operation 410, a substrate is provided. The substrate may be substrate(s) 118 as shown in FIGS. 1-3. The substrate may be positioned in the processing volume 106 by the substrate support pedestal 116. In some embodiments, the substrate is a semiconductor substrate including silicon. Alternatively, in other embodiments, the substrate includes an elementary semiconductor including silicon and/or germanium in crystal; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or a combination thereof. In some embodiments, where the substrate is an alloy semiconductor; the alloy semiconductor substrate has a gradient SiGe feature in which the Si and Ge composition change from one ratio at one location to another ratio at another location of the gradient SiGe feature. In some embodiments, the alloy SiGe is formed over a silicon substrate, and/or the SiGe substrate is strained. In yet another alternative, the semiconductor substrate is a semiconductor on insulator (SOI).

In some embodiments, the substrate includes various doped regions depending on design requirements as known in the art (e.g., p-type wells or n-type wells). The doped regions may be doped with p-type dopants, such as boron or BF2, and/or n-type dopants, such as phosphorus or arsenic. In some embodiments, the doped regions are formed directly on the substrate(s) 118, in a P-well structure, in an N-well structure, in a dual-well structure, or using a raised structure. The doped regions may include various active regions, such as regions configured for an N-type metal-oxide-semiconductor transistor (referred to as an NMOS) and regions configured for a P-type metal-oxide-semiconductor transistor (referred to as a PMOS).

At operation 420, the substrate is exposed to continuous electromagnetic energy. After the substrate(s) 118 is positioned in the processing volume 106, the first electromagnetic energy source 130 is turned on. The first electromagnetic energy source 130 may be positioned to heat the entire substrate(s) 118. Prior to or during operation 420, an anneal gas (or gas mixture) or other suitable process gas mixture may be supplied to the processing volume 106 from the gas supply 150 via the gas inlet 152 and exits through the exhaust port 172. In some embodiments, the anneal gas includes an inert gas, such as He, Ar, Xe, N2, or a combination thereof and/or a process gas, such as an oxygen-containing gas, for example, oxygen.

In some embodiments, where the first electromagnetic energy source 130 is a continuous microwave source, the frequency of microwave supplied by the first electromagnetic energy source 130 to the processing volume 106 may be in a range from about 1 GHz to about 30 GHz. In another embodiment the frequency of microwave supplied is in a range from about 1 GHz to about 10 GHz, or in a range from about 2 GHz to about 5 GHz. However, other applicable frequencies may also be used. The power of microwave may be in range from about 1000 watts to about 7000 watts, or in a range from about 1000 watts to about 3000 watts. In one example, the microwave generator outputs 1500 watts of power at a frequency of about 2.54 gigahertz (GHz).

In some embodiments, the process time for the operation 420 is in a range from about 50 seconds to about 100 seconds. The substrate(s) 118 may be heated to a temperature in a range from room temperature and at peak temperatures below the melting point of the semiconducting material of the substrate(s) 118. The substrate(s) 118 may be heated at a temperature in a range from about 350 degrees Celsius to about 500 degrees Celsius, in accordance with some embodiments.

At operation 430, the substrate is exposed to electromagnetic pulses while maintaining application of the continuous electromagnetic energy of operation 420. The electromagnetic pulses may be supplied by the second electromagnetic energy source 140. As described herein, the second electromagnetic energy source 140 may be configured to heat a portion of the substrate(s) 118 while the first electromagnetic energy source 130 may be configured to heat the entire substrate(s) 118. The second electromagnetic energy source 140 may be an optical radiation source (e.g., a laser). In particular embodiments, the second electromagnetic energy source 140 is a pulsed laser source, for example, a nanosecond pulsed laser source. In one example, each pulse has a duration in a range from about 1 nanosecond to about 10 milliseconds long, or in a range from about 1 nanosecond to 100 nanoseconds, or in a range from about 10 nanoseconds to 100 nanoseconds, or in a range from about 1 nanosecond to about 10 nanoseconds. The laser may have a pulse repetition frequency in the range of 80 kHz to 1 MHz or in the range of 100 kHz to 500 kHz.

In some embodiments, the nanosecond pulsed laser anneals described herein include multiple laser pulses in the nanosecond range of a semiconductor material, or stack of materials including a semiconductor material, at peak temperatures below the melting point of the semiconducting material. In particular embodiments, the multiple nanosecond pulsed laser anneals have a peak temperature in a range from about 800 degrees Celsius to about 1400 degrees Celsius, with a laser pulse duration of 10 to 100 nanoseconds (nSec), ranging from 1 to 100 pulses or ranging from 5 to 100 pulses, for example. In some embodiments, the cumulative laser exposure time ranges from 100 nanoseconds to 3 microseconds.

In some embodiments, the electromagnetic pulses provided by the second electromagnetic energy source 140 may be coordinated with the continuous electromagnetic energy from the first electromagnetic energy source 130. The phase of the continuous electromagnetic energy may be monitored and the pulse provided by the second electromagnetic source may be coordinated with the phase of the continuous electromagnetic energy to achieve a unique material state. For example, the phase-frequency detector 136 may be used in a feedback process, where the phase-frequency detector 136 detects the phase, frequency, and/or other parameters of the emitted electromagnetic energy 135 and the system controller 160 adjusts the parameters of the first electromagnetic energy source 130 and/or the parameters of the second electromagnetic energy source 140 based on input from the phase-frequency detector 136. In other embodiments, a feed forward type process may be used to determine when to pulse the emitted energy of the second electromagnetic energy source 140. For example, substrates of similar materials may be processed and once targeted processing parameters are determined, these targeted processing parameters may be used to process subsequent substrates.

It should be understood that although operation 420 is depicted as starting prior to operation 430, in some embodiments, it may be desirable to begin operation 430 prior to operation 420.

At operation 440, a result of the method 400 may be monitored and an endpoint of the method 400 may be detected at operation 450.

In the Summary and in the Detailed Description, and the claims, and in the accompanying drawings, reference is made to particular features (including method steps) of the present disclosure. It is to be understood that the disclosure in this specification includes all possible combinations of such particular features. For example, where a particular feature is disclosed in the context of a particular aspect or implementation of the present disclosure, or a particular claim, that feature can also be used, to the extent possible in combination with and/or in the context of other particular aspects and implementations of the present disclosure, and in the present disclosure generally.

The term “comprising,” “including” and “having” and grammatical equivalents thereof are used herein to mean that other components, ingredients, operations, etc. are optionally present. For example, an article “comprising” (or “which comprises”) components A, B, and C can consist of (i.e., contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Embodiments and all of the functional operations described in this specification can be implemented in digital electronic circuitry, or in computer software, firmware, or hardware, including the structural means disclosed in this specification and structural equivalents thereof, or in combinations of them. Embodiments described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the foregoing is directed to embodiments of the present disclosure, other and further embodiments of the disclosure may be devised without departing from the basic scope thereof, and the scope thereof is determined by the claims that follow.

1. A system for annealing a substrate, suitable for use in semiconductor processing, comprising:
a chamber body defining a processing volume;
a substrate support pedestal positioned in the processing volume and movable in an x-y plane, wherein the substrate support pedestal is operable to support a substrate having a major surface;
a continuous source of microwave energy coupled with the chamber body via a waveguide, the continuous source of microwave energy is positioned to deliver microwave energy to the substrate; and
a pulsed laser source positioned to deliver pulses of laser energy to the substrate.

2. The system of claim 1, wherein the pulsed laser source is selected from a femtosecond laser source, a picosecond laser source, or a nanosecond laser source.

3. The system of claim 1, wherein each pulse from the pulsed laser source has a duration in a range from about 1 nanosecond to about 100 nanoseconds.

4. The system of claim 3, wherein the pulsed laser source has a pulse repetition frequency in the range of 80 kHz to 1 MHz.

5. The system of claim 2, wherein the pulsed laser source is positioned to deliver the pulses of laser energy perpendicular to the major surface of the substrate.

6. The system of claim 5, wherein the continuous source of microwave energy is positioned to deliver microwave energy parallel to the major surface of the substrate.

7. The system of claim 5, further comprising a system controller connected with the continuous source of microwave energy and the pulsed laser source, wherein the system controller coordinates a phase of the continuous source of microwave energy with the pulses of laser energy provided by the pulsed laser source.

8. A system for annealing a substrate, comprising:
a chamber body defining a processing volume, the chamber body, comprising:
a top wall;
a bottom wall opposing the top wall; and
a sidewall coupling the top wall and the bottom wall;
a substrate support pedestal positioned in the processing volume and movable in an x-y plane parallel to the top wall, wherein the substrate support pedestal is operable to support a substrate having a major surface;
a continuous source of electromagnetic energy coupled with the chamber body via a waveguide, the continuous source of electromagnetic energy is positioned to deliver electromagnetic energy to the substrate; and
a pulsed source of electromagnetic energy positioned to deliver pulses of electromagnetic energy to the substrate.

9. The system of claim 8, wherein the continuous source of electromagnetic energy is a microwave source and the pulsed source of electromagnetic energy is a laser source.

10. The system of claim 9, wherein the pulsed source of electromagnetic energy is positioned to deliver pulses of electromagnetic energy perpendicular to the major surface of the substrate.

11. The system of claim 10, wherein the continuous source of electromagnetic energy is positioned to deliver microwave energy parallel to the major surface of the substrate.

12. The system of claim 8, further comprising a phase-frequency detector operable to detect a phase and/or a frequency of the electromagnetic energy emitted from the continuous source of electromagnetic energy.

13. The system of claim 12, further comprising a system controller connected with the phase-frequency detector and the continuous source of electromagnetic energy, wherein the system controller adjusts the pulsed source of electromagnetic energy based on input from the phase-frequency detector.

14. A method of annealing a substrate, comprising:
applying continuous electromagnetic energy from a first electromagnetic energy source to a substrate, wherein the substrate has a major surface; and
exposing the substrate to pulses of laser energy from a second electromagnetic energy source while applying the continuous electromagnetic energy, wherein exposing the substrate to the pulses of laser energy occurs in phase with the continuous electromagnetic energy.

15. The method of claim 14, wherein the continuous electromagnetic energy heats the substrate and the pulses of laser energy heat a defined region of the major surface of the substrate.

16. The method of claim 15, wherein the first electromagnetic energy source is a microwave source.

17. The method of claim 14, wherein the second electromagnetic energy source is a pulsed laser source selected from a femtosecond pulsed laser source, a picosecond pulsed laser source, or a nanosecond pulsed laser source.

18. The method of claim 17, wherein each pulse of the pulses of laser energy has a duration in a range from about 1 nanosecond to about 100 nanoseconds.

19. The method of claim 18, wherein the pulsed laser source has a pulse repetition frequency in the range of 80 kHz to 1 MHz.

20. The method of claim 19, wherein the pulsed laser source is positioned to deliver the pulses of laser energy perpendicular to the major surface of the substrate and the first electromagnetic energy source is positioned to deliver microwave energy parallel to the major surface of the substrate.
